(19) United States
(12) Patent Application Publication
(10) Pub. No.: US 2010/0033505 A1
(43) Pub. Date: Feb. 11, 2010

(54) METHOD FOR PARTIALLY ZOOMING A SCREEN OF A DISPLAY, AND ELECTRONIC DEVICE APPLYING THE METHOD

(75) Inventor: I-Pin Hsieh, Taipei (TW)

Correspondence Address: CHOATE, HALL & STEWART LLP, TWO INTERNATIONAL PLACE, BOSTON, MA, 02110, US

(73) Assignee: Wistron Corporation, Taipei Hsien (TW)

(21) Appl. No.: 12/464,459

(22) Filed: May 12, 2009

(30) Foreign Application Priority Data
Aug. 6, 2008 (TW) 097129817

(51) Int. Cl. G09G 5/00

(52) U.S. Cl. 345/660

(57) ABSTRACT

A method for partially zooming a screen of a display includes: defining a portion of the screen of the display as a zoom area and the rest of the screen as a normal area; retrieving video data to be displayed in the normal area of the screen, storing the video data in a normal data memory block of a video memory that corresponds to the normal area, further retrieving video data to be displayed in the zoom area of the screen, performing zoom processing of the retrieved video data, and storing the zoom-processed video data in a zoom data memory block of the video memory that corresponds to the zoom area; and subsequently reading the video data stored in the normal data memory block and the zoom data memory block of the video memory, and sending the video data thus read to the display for displaying.

### CROSS-REFERENCE TO RELATED APPLICATION

This application claims priority of Taiwanese Application No. 097129817, filed on Aug. 6, 2008, which is incorporated herein by reference.

### BACKGROUND OF THE INVENTION

1. Field of the Invention

The invention relates to a method of displaying on a display screen, more particularly to a method for partially zooming a screen of a display, and to an electronic device applying the method.

2. Description of the Related Art

A notebook computer of the latest generation differs from a conventional notebook computer in the size and resolution of the liquid crystal display thereof. The liquid crystal display of the conventional notebook computer generally has a resolution of 1024×768 pixels, whereas the latest notebook computer has a liquid crystal display with a resolution of 1600×600 pixels, providing users with a new way of using notebook computers. Because the latest widescreen liquid crystal display is wider from left to right and narrower from top to bottom and has a higher resolution, the pitch between two adjacent pixels is smaller compared to a conventional liquid crystal display, so that the displayed characters appear smaller, though finer. When a user browses or edits a document, his/her eyes may feel uncomfortable looking at a screen with overly small characters, which may adversely affect the document browsing or editing operation.

Therefore, if the content displayed in a specific displaying region or editing (operating) region of a screen of the aforesaid widescreen display or even a conventional display can be partially magnified to enable the user to clearly and comfortably read the content in the specific displaying or editing region so as to make it easier for the user to perform text editing or operation through the screen, it may help promote and popularize use of the aforesaid widescreen display or an electronic device, such as a notebook computer, having the aforesaid widescreen display.

### SUMMARY OF THE INVENTION

Therefore, an object of the present invention is to provide a method for partially zooming a screen of a display which can be used to suitably zoom a specific area of the screen of the display to facilitate viewing and operation by a user, and to provide an electronic device applying the method.

Accordingly, an embodiment of the method for partially zooming a screen of a display of the present invention includes: (a) defining a portion of the screen of the display as a zoom area and the rest of the screen as a normal area; (b) retrieving video data to be displayed in the normal area of the screen, storing the video data in a normal data memory block of a video memory that corresponds to the normal area, further retrieving video data to be displayed in the zoom area of the screen, performing zoom processing of the retrieved video data, and storing the zoom-processed video data in a zoom data memory block of the video memory that corresponds to the zoom area; and (c) reading the video data stored in the normal data memory block and the zoom data memory block of the video memory, and sending the video data thus read to the display for displaying.

An electronic device for realizing the aforesaid method of the present invention is capable of controlling partial zooming of a screen of a display. In some embodiments, the electronic device includes a video memory, a video data buffer unit for storing video data to be displayed, a central processing unit, and a video processing unit. The central processing unit defines a portion of the screen of the display as a zoom area and the rest of the screen as a normal area, retrieves video data to be displayed in the normal area from the video data buffer unit, stores the retrieved video data in a normal data memory block of the video memory that corresponds to the normal area, further retrieves video data to be displayed in the zoom area from the video data buffer unit, performs zoom processing of the video data to be displayed in the zoom area, and stores the zoom-processed video data in a zoom data memory block of the video memory that corresponds to the zoom area. The video processing unit reads the video data stored in the normal data memory block and the zoom data memory block of the video memory, and sends the video data read thereby to the display for displaying.

In some embodiments, the zoom area is located near a central position of the screen of the display so that the normal area is divided into an upper normal area and a lower normal area.

In some embodiments, the video memory includes a first memory block for storing the video data to be displayed in the upper normal area, a second memory block for storing the video data to be displayed in the zoom area, and a third memory block for storing the video data to be displayed in the lower normal area which are arranged sequentially and successively. The normal data memory block includes the first and third memory blocks, and the zoom data memory block includes the second memory block. The video processing unit reads the video data from the first memory block, the second memory block, and the third memory block in sequence and sends the video data read thereby to the display.

In some embodiments, the zoom data memory block is located after the normal data memory block. The normal data memory block includes a first memory block for storing the video data to be displayed in the upper normal area, and a second memory block for storing the video data to be displayed in the lower normal area. The first and second memory blocks are spaced apart by a blank memory space of a size equivalent to that of the zoom data memory block.

In some embodiments, the central processing unit stores window data in a third memory block located between the second memory block and the zoom data memory block of the video memory. When the window data is read by the video processing unit and is sent to the display for displaying on the screen, a zoom window is generated in the zoom area of the screen of the display. The video processing unit reads the video data from the normal data memory block, the third memory block, and the zoom data memory block in sequence, and sends the video data read thereby to the display for displaying.

In some embodiments, the electronic device is a notebook computer, and the display is a display of the notebook computer.

### BRIEF DESCRIPTION OF THE DRAWINGS

Other features and advantages of the present invention will become apparent in the following detailed description of the preferred embodiments with reference to the accompanying drawings, of which:

FIG. 1 is a circuit block diagram of an embodiment of an electronic device;

FIG. 2 is a flowchart to illustrate a partial zoom-in process executed by an embodiment of the electronic device;

FIG. 3 is a schematic diagram of an embodiment of a screen of a display prior to partial zoom-in;

FIG. 4 is a schematic diagram to illustrate an embodiment of how video data contents corresponding to the data displayed on the screen of FIG. 3 are stored in a video memory;

FIG. 5 is a schematic diagram to illustrate an embodiment of how the screen is defined into a zoom-in area and a normal area;

FIG. 6 is a schematic diagram to illustrate an embodiment of how the video data contents corresponding to the zoom-in area and the normal area of the screen are stored in the video memory;

FIG. 7 is a schematic diagram to illustrate an embodiment of how the video data is displayed on the screen with a portion of the data zoomed;

FIG. 8 is a schematic diagram to illustrate an embodiment of how the video data contents stored in the video memory are relatively changed in response to a change in the data in the zoom-in area of the screen;

FIG. 9 is a schematic diagram to illustrate an embodiment of a change of the data displayed in the zoom-in area of the screen;

FIG. 10 is a flowchart of an embodiment of a partial zoom-in process executed by an electronic device;

FIG. 11 is a schematic diagram to illustrate an embodiment of how video data contents corresponding to the zoom-in and normal areas of the screen shown in FIG. 5 are stored in a video memory;

FIGS. 12 and 13 are schematic diagrams to illustrate an embodiment of how the video data contents are displayed in the zoom-in and normal areas of the screen;

FIG. 14 is a circuit block diagram of another embodiment of an electronic device;

FIG. 15 is a schematic diagram to illustrate that only a left portion of video data contents can be shown on a screen of a display of an embodiment of the electronic device under normal displaying conditions;

FIG. 16 is a schematic diagram to illustrate an embodiment of the video data contents corresponding to those shown on the screen of FIG. 15 are stored in a video memory;

FIG. 17 is a schematic diagram to illustrate an embodiment of the video data contents stored in a video data buffer unit;

FIG. 18 is a schematic diagram to illustrate an embodiment that only a right portion of the video data contents can be displayed on the screen of the display of the electronic device under normal displaying conditions;

FIG. 19 is a flowchart to illustrate an embodiment of a partial zoom-out process executed by the electronic device;

FIG. 20 is a schematic diagram to illustrate an embodiment normal area and a zoom-out area of the display of the electronic device;

FIG. 21 is a schematic diagram to illustrate an embodiment of how the video data contents corresponding to the normal and zoom-out areas of the screen of FIG. 20 are stored in the video memory;

FIG. 22 is a schematic diagram to illustrate an embodiment of how a portion of the video data contents displayed on the display of the electronic device is zoomed out;

FIG. 23 is a schematic diagram to illustrate an embodiment of how the video data contents stored in the video memory are relatively changed in response to a change in the data in the zoom-out area of the screen;

FIG. 24 is a schematic diagram to illustrate an embodiment of a change of the data displayed in the zoom-out area of the screen;

FIG. 25 is a flowchart to illustrate an embodiment of a partial zoom-out process executed by an electronic device;

FIG. 26 is a schematic diagram to illustrate an embodiment of how video data contents corresponding to the zoom-out and normal areas of the screen of FIG. 20 are stored in a video memory; and

FIGS. 27 and 28 are schematic diagrams to illustrate an embodiment of how the video data contents are displayed in the normal and zoom-out areas of the screen.

### DETAILED DESCRIPTION

Before embodiments of the present invention are described in greater detail, it should be noted that like elements are denoted by the same reference numerals throughout the disclosure.

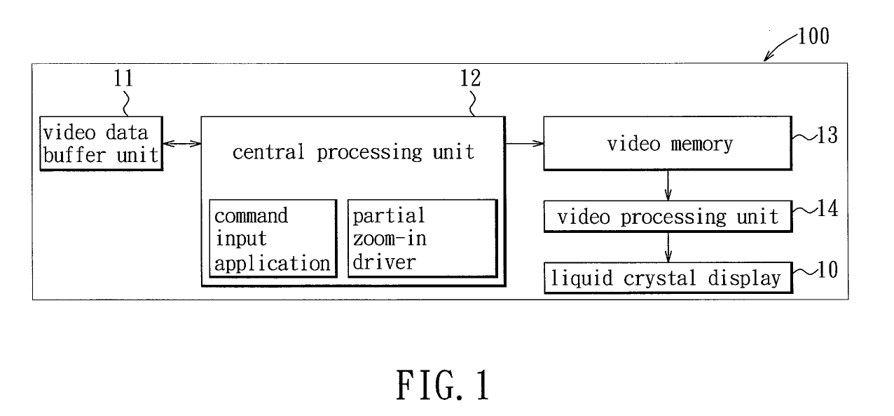

Reference is made to FIG. 1, which illustrates an embodiment of an electronic device. The electronic device is exemplified as a notebook computer 100 in this embodiment, which has a widescreen liquid crystal display (hereinafter referred to as the display) 10 having a 1600×600 pixel array. FIG. 1 illustrates main circuit blocks of the notebook computer 100 which are used to control partial zoom-in or magnification of a displayed screen of the display 10, and which include a video data buffer unit 11, a central processing unit 12, a video memory 13, and a video processing unit 14.

The video data buffer unit 11 is a space where the central processing unit 12 accesses data and where source video (image) data to be displayed is stored temporarily, and may be a main memory or a hard disk.

The video memory (video RAM, generally referred to as VRAM) 13 stores video (image) data that is being sent to the display 10 for displaying.

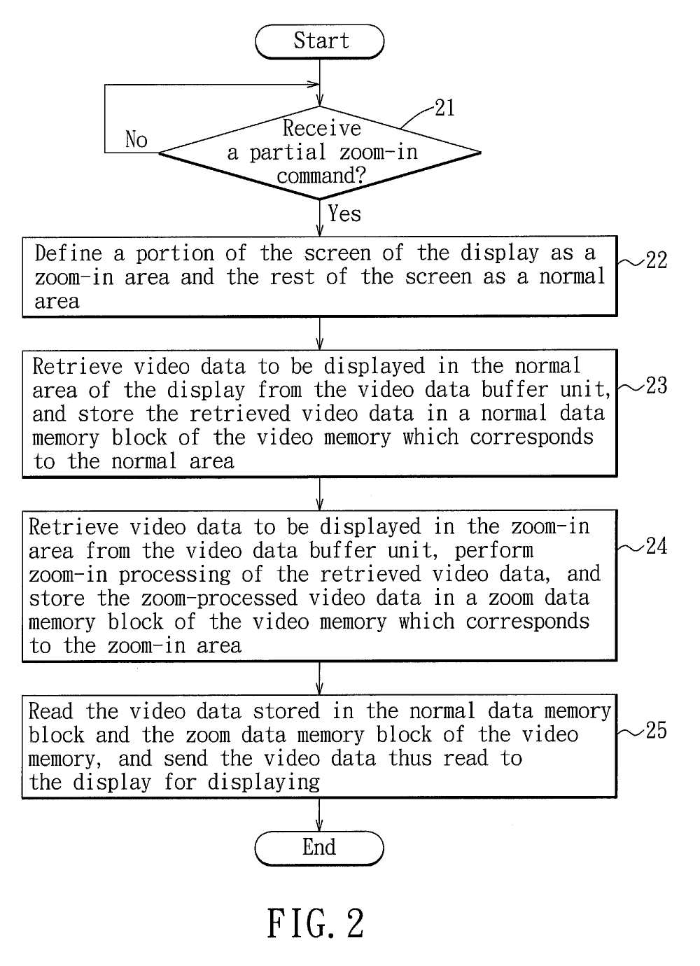

The central processing unit 12 is loaded with a partial zoom-in or magnification driver and a command input application for requesting execution of the partial zoom-in driver. The command input application provides a “partial zoom-in” option on the screen of the display 10 for selection by the user. As shown in step 21 of FIG. 2, when the “partial zoom-in” option is selected, the command input application sends a partial zoom-in command to the central processing unit 12 to enable the central processing unit 12 to execute the partial zoom-in driver. Therefore, when the partial zoom-in driver is executed, in step 22, the central processing unit 12 first defines a portion of the screen of the display 10 as a zoom-in area and the rest of the screen as a normal area. Generally, the zoom-in area is located at a position where the user will normally look at, i.e., near a middle or central portion of the screen. Moreover, the zoom-in area is presented as occupying a plurality of lines. In other words, in a word processing environment, for the purpose of enlarging characters in the zoom-in area, the zoom-in area will occupy at least two lines on the screen so that characters in the zoom-in area are larger than those in the normal area by at least two folds.

Subsequently, in step 23, the central processing unit 12 retrieves video data to be displayed in the normal area of the display 10 from the video data buffer unit 11 and stores the retrieved video data in a normal data memory block of the video memory 13 which corresponds to the normal area. Next, step 24 is performed, in which the central processing unit 12 acquires video data to be displayed in the zoom-in area from the video data buffer unit 11, performs zoom-in processing of the acquired video data, and stores the zoom-processed video data in a zoom data memory block of the video memory 13 which corresponds to the zoom-in area.

Thus, in step 25, when the video processing unit 14 reads the video data stored in the normal data memory block and the zoom data memory block of the video memory 13 and sends the video data read thereby to the display 10 for displaying, the zoom-processed video data is presented in the zoom-in area of the displayed screen of the display 10, while the video data displayed in the normal area is presented in its original size. The present invention will be illustrated hereinbelow by way of an example.

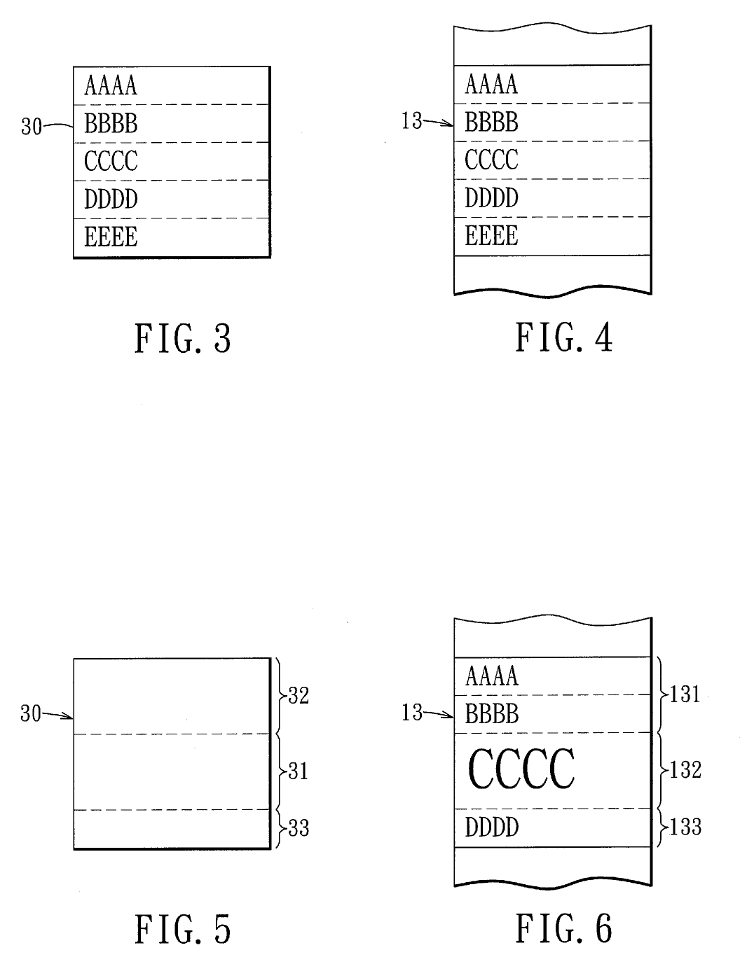

Referring to FIG. 3, supposing a screen 30 of an editing window generated by word processing software on the display 10 can only show five lines of text content, the five lines of text content are stored in a memory block of the video memory 13 as shown in FIG. 4.

However, since the pitch between adjacent pixels of the widescreen display 10 is smaller compared to a conventional liquid crystal display, the characters shown in the screen 30 will be too small, which may hence affect the reading or editing of the text. The user can then utilize the “partial zoom-in” option provided by the command input application to select partial zoom-in, so as to enable the central processing unit 12 to execute the partial zoom-in driver. Referring to FIG. 5, lines 3 and 4 on the screen 30 are defined as a zoom-in area 31, the rest being a normal area. Since the zoom-in area 31 is provided at a substantially middle position of the screen 30, the normal area is divided into an upper normal area 32 (i.e., lines 1 and 2) and a lower normal area 33 (i.e., line 5). The purpose of the zoom-in area 31 is such that the text, e.g., “CCCC,” located therein will be zoomed-in or magnified. Moreover, in order that the text in the zoom-in area 31 will not cover up the text in the upper normal area 32 and the lower normal area 33, the text “DDDD” and “EEEE” originally shown in lines 4 and 5 is moved one line down, so that the text “EEEE” is pushed out of the screen 30. In order to achieve this effect, the central processing unit 12, once again, reads the video data (i.e., “AAAA” and “BBBB”) to be displayed in the upper normal area 32 (i.e., lines 1 and 2) from the video data buffer unit 11, and stores the video data read thereby in a first memory block 131 of the video memory 13 as shown in FIG. 6. The central processing unit 12 further reads the video data to be displayed in the zoom-in area 31, i.e., “CCCC,” from the video data buffer unit 11, performs zoom-in processing of the video data read thereby, and stores the zoom-processed video data in a second memory block 132 of the video memory 13 as shown in FIG. 6. The central processing unit 12 also reads the video data to be displayed in the lower normal area 33, i.e., “DDDD,” from the video data buffer unit 11, and stores the video data read thereby in a third memory block 133 of the video memory 13 as shown in FIG. 6. The first, second and third memory blocks 131, 132, 133 are arranged in sequence in the video memory 13 at consecutive positions. In other words, the first memory block 131 and the third memory block 133 are normal data memory blocks for storing normal video data.

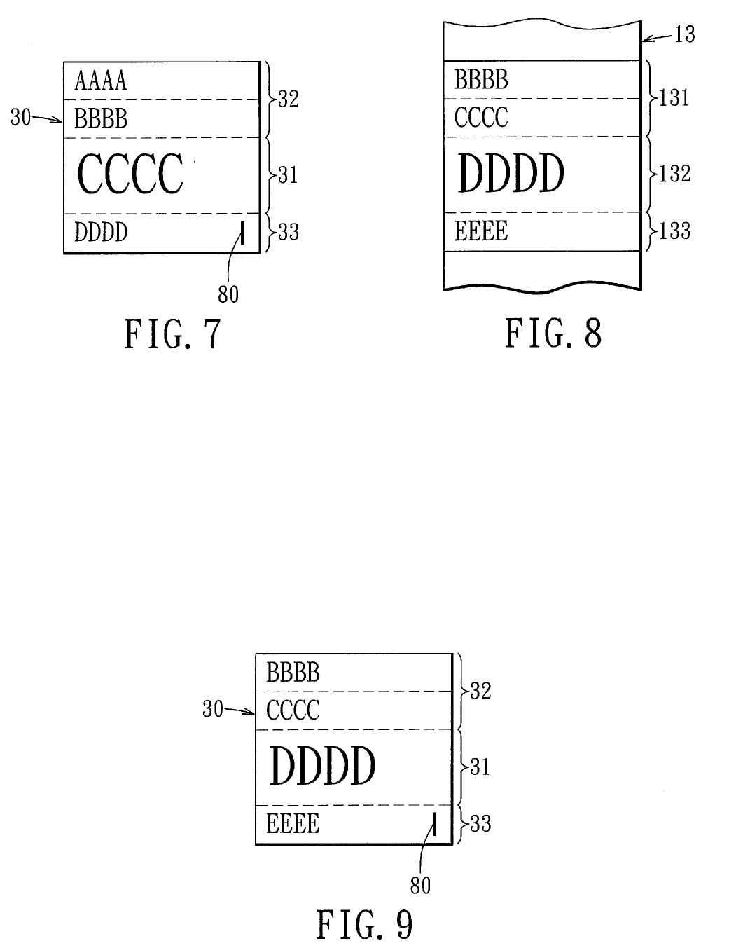

Thus, when the video processing unit 14 reads the video data from the first, second and third memory blocks 131, 132, 133 of the video memory 13 and sends the same to the display 10 for displaying, as shown in FIG. 7, the video data “CCCC” in magnified form is displayed in the zoom-in area 31 of the screen 30 of the editing window on the display 10, and the video data “AAAA,” “BBBB,” and “DDDD” are displayed in their normal form in the upper and lower normal areas 32, 33 correspondingly.

In addition, when a cursor 80 (see FIG. 7) on the current screen 30 is at the last line, i.e., line 5 (fourth line of text), if the user moves the cursor 80 down one line, the central processing unit 12 updates the video data stored in the video memory 13 in real time by retrieving, once again, the corresponding video data from the video data buffer unit 11, and storing the retrieved or retrieved and zoom-processed video data in the first, second and third memory blocks 131, 132, 133 of the video memory 13 as shown in FIG. 8. Therefore, as shown in FIG. 9, the text “EEEE” at the line where the cursor 80 is currently at will come into view and appear on the screen 30, while the first line of text “AAAA” will be pushed out of the screen 30. At the same time, the line of text “DDDD” immediately above the line where the cursor 80 is at will move into the zoom-in area 31 and be magnified.

Accordingly, through the above-described mechanism, the text content a user is looking at or is editing can be timely magnified to assist the user to perform a text editing task or operation via the screen 30 of the display 10, particularly if the display 10 is a liquid crystal display with a relatively high resolution.

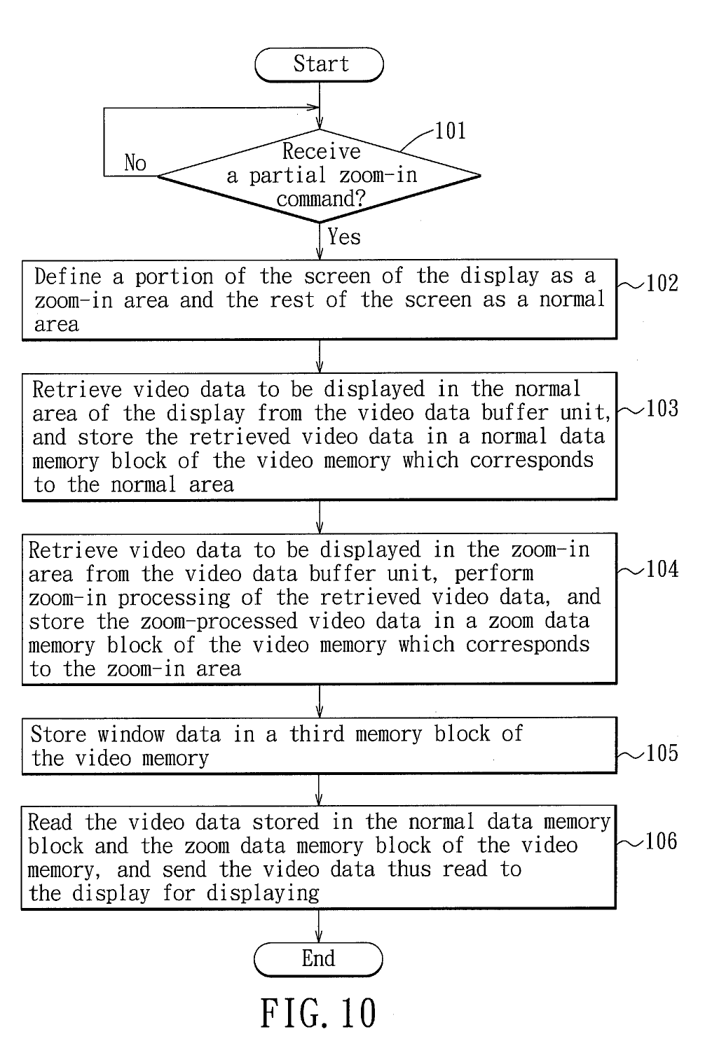

In another embodiment of an electronic device, the circuit blocks thereof are completely identical to those of the embodiment described above. The only difference is that the central processing unit 12 performs the partial zoom-in function by executing a partial zoom-in application instead of by executing the partial zoom-in driver. The process carried out by the partial zoom-in application to magnify a portion of the content shown on a screen will be described in detail below by way of an example with reference to FIG. 10.

Supposing it is also desired to magnify the line of text “CCCC” on the screen 30 shown in FIG. 3 in this embodiment, when the partial zoom-in application receives a “partial zoom-in command” in step 101 of FIG. 10, in step 102, lines 3 and 4 of the screen 30 are defined as the zoom-in area 31 and the rest of the screen 30 is defined as the normal area (including the upper normal area 32 and the lower normal area 33), as shown in FIG. 5.

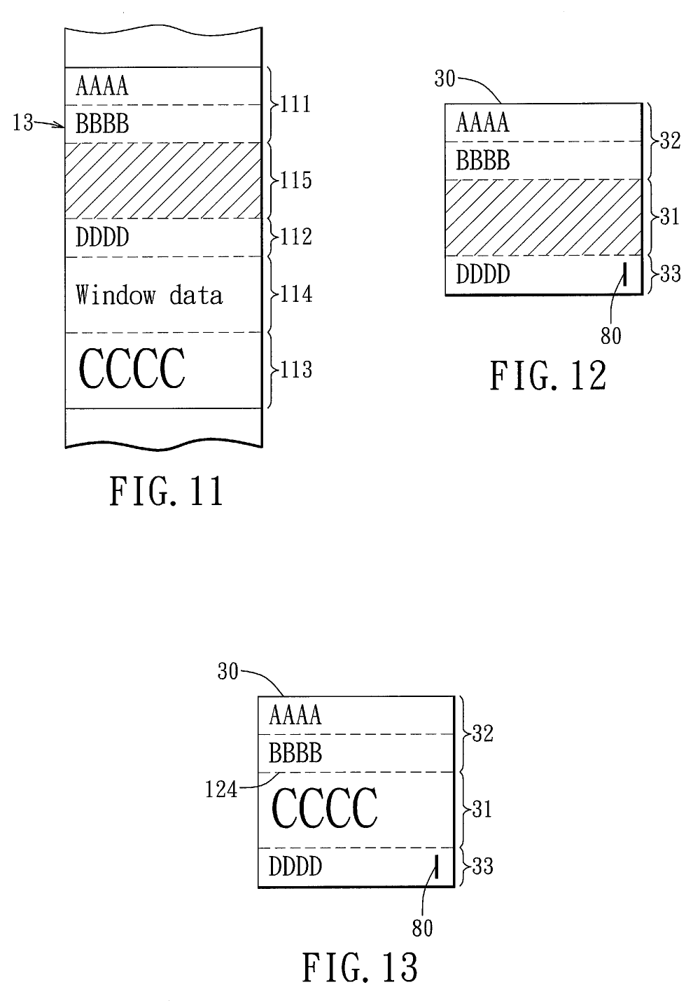

Subsequently, in step 103, the central processing unit 12 reads video data to be displayed in the upper normal area 32 (i.e., lines 1 and 2), i.e., “AAAA” and “BBBB,” from the video data buffer unit 11, and stores the video data read thereby in a first memory block 111 of the video memory 13 as shown in FIG. 11, and further reads the video data to be displayed in the lower normal area 33, i.e., “DDDD,” from the video data buffer unit 11 and stores the video data read thereby in a second memory block 112 of the video memory 13. Thereafter, in step 104, the central processing unit 12 reads the video data to be displayed in the zoom-in area 31, i.e., “CCCC,” from the video data buffer unit 11, performs zoom-in processing of the video data read thereby, and stores the zoom-processed video data in a zoom data memory block 113 of the video memory 13 as shown in FIG. 11. Moreover, in step 105, window data to be displayed in the zoom-in area 31 is stored in a third memory block 114 of the video memory 13. The first memory block 111 and the second memory block 112 are not arranged contiguously but in sequence in different regions of the video memory 13, with a blank memory space 115 of a size equivalent to that of the zoom data memory block 113 therebetween. The third memory block 114 and the zoom data memory block 113 are arranged in sequence after the second memory block 112.

Accordingly, in step 106, when the video processing unit 14 is controlled by the central processing unit 12 to read, in sequence, the video data from the first memory block 111, the blank memory space 115, and the second memory block 112 of the video memory 13 and to send the video data read thereby to the display 10, as shown in FIG. 12, the video data “AAAA,” “BBBB,” and “DDDD” of normal size will be correspondingly displayed in the upper normal area 32 (i.e., lines 1 and 2) and the lower normal area 33 (i.e., line 5 or fourth line of text), and a blank space is displayed in the zoom-in area 31 (i.e., lines 3 and 4) between lines 2 and 5. When the video processing unit 14 subsequently reads the window data in the third memory block 114 of the video memory 13, as shown in FIG. 13, a zoom-in window 124 will be generated and will overlap the blank space in the zoom-in area 31. When the video processing unit 14 continues to read the zoom-processed video data “CCCC” from the zoom data memory block 113 of the video memory 13 and sends the same to the display 10, the zoom-processed video data “CCCC” will be displayed in the zoom-in window 124.

Similarly, as in FIGS. 7 and 8, when the cursor 80 is at the last line, i.e., line 5, if the user controls the cursor 80 to move down one line, the central processing unit 12 updates the video data stored in the video memory 13 in real time by retrieving, once again, the corresponding video data from the video data buffer unit 11, and storing the retrieved video data in the first and second memory blocks 111, 112, and the retrieved and zoom-processed video data (“DDDD”) in the zoom data memory block 113 of the video memory 13 as shown in FIG. 11, so that the next line of text “EEEE” where the cursor 80 is currently located appears on the screen 30, while the first line of text “AAAA” is pushed out of the screen 30, with the line of text “DDDD” immediately above the line where the cursor 80 is currently at being presented in the zoom-in window 124 and being magnified, as shown in FIG. 9.

In a similar manner, when the user reaches the end of the line of text in the zoom-in window 124 and advances to the beginning of the next line, the magnified text originally in the zoom-in window 124 will be immediately moved up one line and be restored to the normal type size, whereas the line of text newly inputted into the zoom-in window 124 is magnified by the central processing unit 12. In other words, the zoom-in window 124 is fixed in the positions of lines 3 and 4 on the screen 30. Any text inputted into the zoom-in window 124 will be magnified.

In addition, it is worth noting that, while the provision of the zoom-in window 124 in this embodiment helps the video processing unit 14 send the zoom-processed video data to the correct position of the display 10 for displaying, the zoom-in window 124 is not essential. Without the zoom-in window 124, the zoom-processed video data can still be directly superimposed upon and shown in the zoom-in area 31 (blank space).

Therefore, through the partial zoom-in application of this embodiment, the text content a user is looking at or is editing can be timely magnified to assist the user to perform a text editing task or operation via the screen 30 of the display 10, particularly if the display 10 is a liquid crystal display with a relatively high resolution.

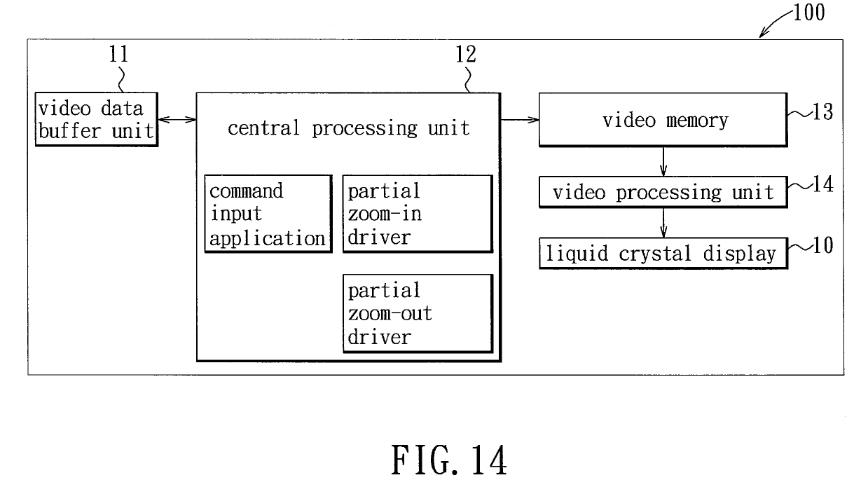

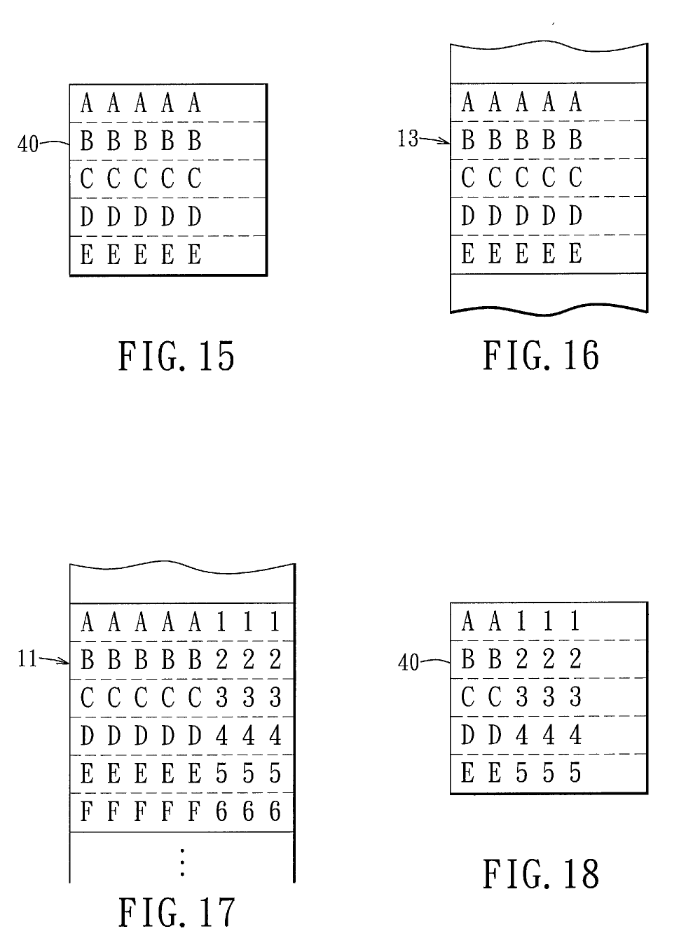

FIG. 14 shows another embodiment of an electronic device. If the size of the display 10 of the electronic device is not large enough, as shown in FIG. 15, a screen 40 generated on the display 10 may only show five lines of text, each line containing five characters, under normal displaying conditions. The five lines of text are stored correspondingly in a memory block of the video memory 13 shown in FIG. 16. However, the text to be displayed on the display 10 as stored in the video data buffer unit 11 actually occupies eight lines, each line containing eight characters. Since the video memory 13 can only store a portion of the video data corresponding to the screen 40, e.g., first five characters of each displayed line, the user is unable to view a complete line of text and needs to scroll left and right in order to be able to view the rest of the text in the line, as shown in FIG. 18.

In order to overcome this drawback, aside from having the partial zoom-in functionality of other embodiments, this embodiment further has partial zoom-out or reduction functionality, so that all the characters in a line displayed on the screen of the display 10 the user is viewing can be reduced so as to be displayed fully on the screen of the display 10 without requiring additional user manipulation.

Therefore, referring to FIG. 14, this embodiment differs from the embodiment of FIG. 1 in that, aside from having a partial zoom-in driver, the central processing unit 12 further includes a partial zoom-out driver and a command input application for requesting execution of one of the partial zoom-in driver and the partial zoom-out driver.

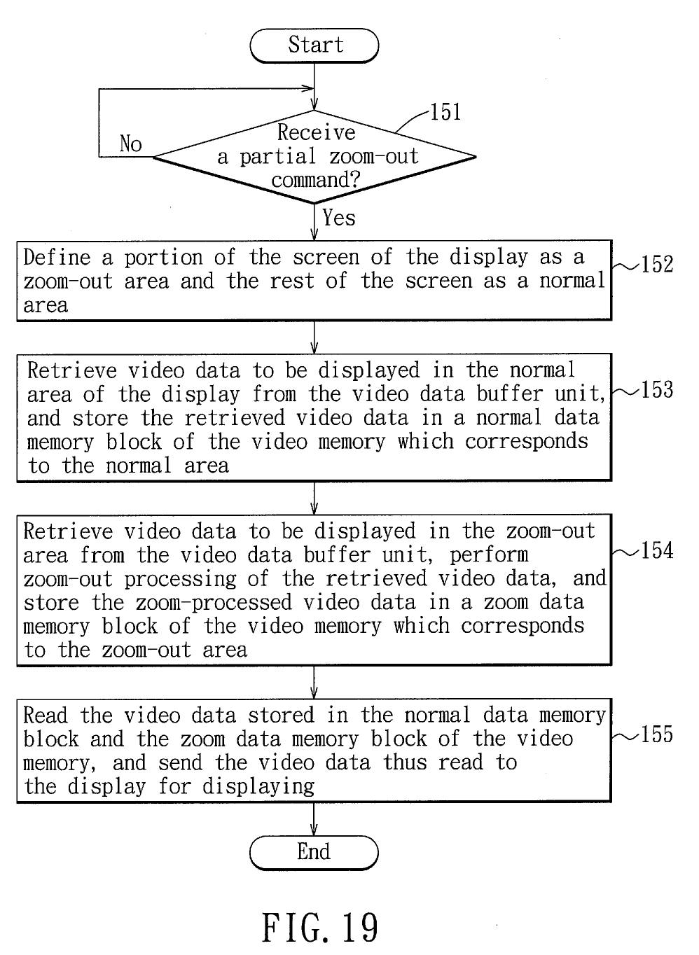

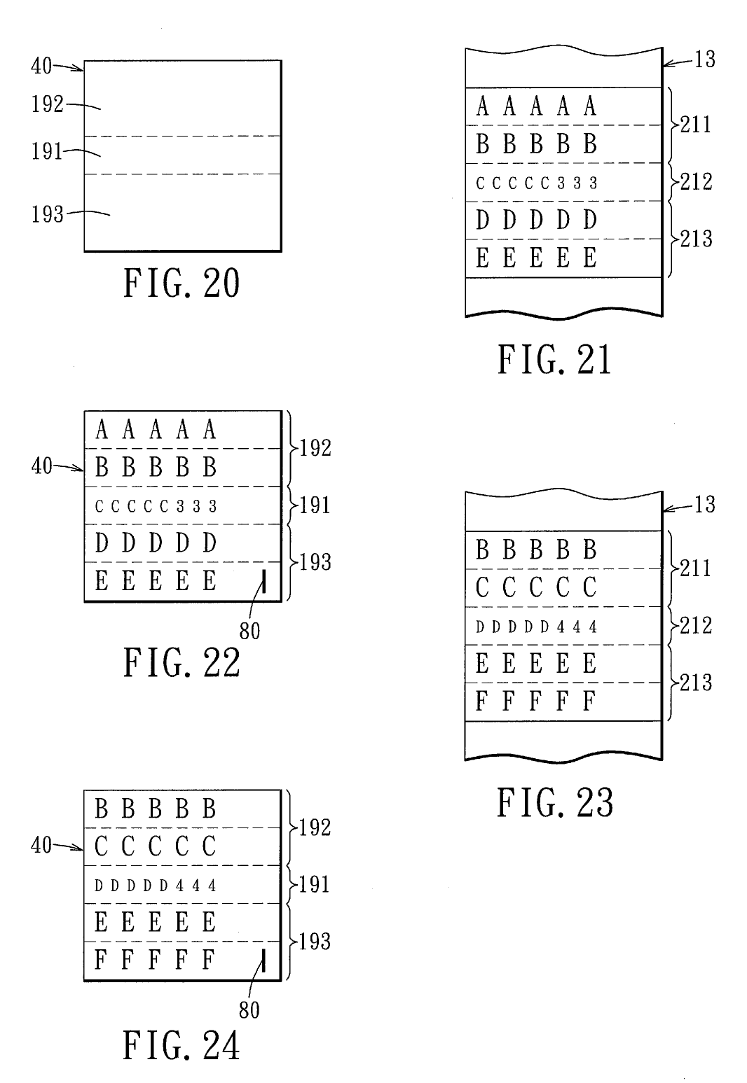

The command input application may provide a “partial zoom-in” option and a “partial zoom-out” option on the screen of the display 10 for selection by the user. As shown in step 151 of FIG. 19, when the “partial zoom-out” option is selected, the command input application sends a partial zoom-out command to the central processing unit 12 to enable the central processing unit 12 to execute the partial zoom-out driver. Therefore, when the partial zoom-out driver is executed, in step 152, the central processing unit 12 first defines a portion of the screen 40 of the display 10 as a zoom-out area 191 and the rest of the screen 40 as a normal area, as shown in FIG. 20. Generally, the zoom-out area 191 is located at a position where the user will normally look at, i.e., near a middle or central portion of the screen 40. The zoom-out area 191 in this embodiment is provided at a substantially middle position, and is presented as occupying one line (e.g., the third line), but should not be limited thereto. The size of the zoom-out area 191 may be increased depending on actual requirements. Therefore, the normal area is divided by the zoom-out area 191 into an upper normal area 192 (i.e., the first and second lines), and a lower normal area 193 (i.e., the fourth and fifth lines). Text in the zoom-out area 191 will be suitably reduced, e.g., reduced to half the size of the original text. Therefore, more characters can be presented in the zoom-out area 191.

In order to achieve such effect, in steps 153 and 154, the central processing unit 12 once again reads the video data to be displayed in the upper normal area 192 of the screen 40 of the display 10, i.e., “AAAAA” and “BBBBB” (only the first five characters of each of the first and second lines are displayed under normal displaying conditions), from the video data buffer unit 11 as shown in FIG. 17, and stores the video data read thereby in a first normal data memory block 211 of the video memory 13 which corresponds to the upper normal area 192, as shown in FIG. 21. The central processing unit 12 further reads the video data to be displayed in the zoom-out area 191 (the third line), i.e., “CCCCC333” (the entire line of text can be displayed due to a reduction in size of the characters), from the video data buffer unit 11, performs zoom-out processing of the video data read thereby, and stores the zoom-processed video data in a second memory block 212 of the video memory 13. The central processing unit 12 also reads the video data to be displayed in the lower normal area 193 from the video data buffer unit 11, i.e., “DDDDD” and “EEEEE,” and stores the video data read thereby in a third memory block 213 of the video memory 13, as shown in FIG. 21. The first, second and third memory blocks 211, 212, 213 are arranged in sequence in the video memory 13 at consecutive positions. In other words, the first memory block 211 and the third memory block 213 are normal data memory blocks for storing normal video data.

Thus, in step 155, when the video processing unit 14 reads the video data in sequence from the first, second and third memory blocks 211, 212, 213 shown in FIG. 21 and sends the video data read thereby to the display 10 for displaying, as shown in FIG. 22, the entire line of video data “CCCCC333” in reduced form is displayed in the zoom-out area 191, and the video data “AAAAA,” “BBBBB,” “DDDDD,” and “EEEEE” are displayed in their normal form in the upper and lower normal areas 192, 193.

Similarly, when a cursor 80 (see FIG. 22) on the current screen 40 is at the last line, i.e., the fifth line, if the user moves the cursor 80 down one line, the central processing unit 12 will update the video data stored in the video memory 13 in real time by retrieving, once again, the corresponding video data from the video data buffer unit 11 and storing the retrieved or retrieved and reduced video data in the first, second and third memory blocks 211, 212, 213. Therefore, as shown in FIG. 24, all the video data shown on the screen 40 is moved one line up, so that the first line of text “AAAAA” is pushed out of the screen 40, new text “FFFFF” appears on the screen 40 at the last line, and the entire line of text “DDDDD444” in reduced form is displayed in the zoom-out area 191 of the screen 40.

Accordingly, through the above-described mechanism, the text content the user is looking at can be timely reduced, so that the user can view entire lines of text content by scrolling up and down. There is no need to scroll left and right in order to view the entire lines of text content.

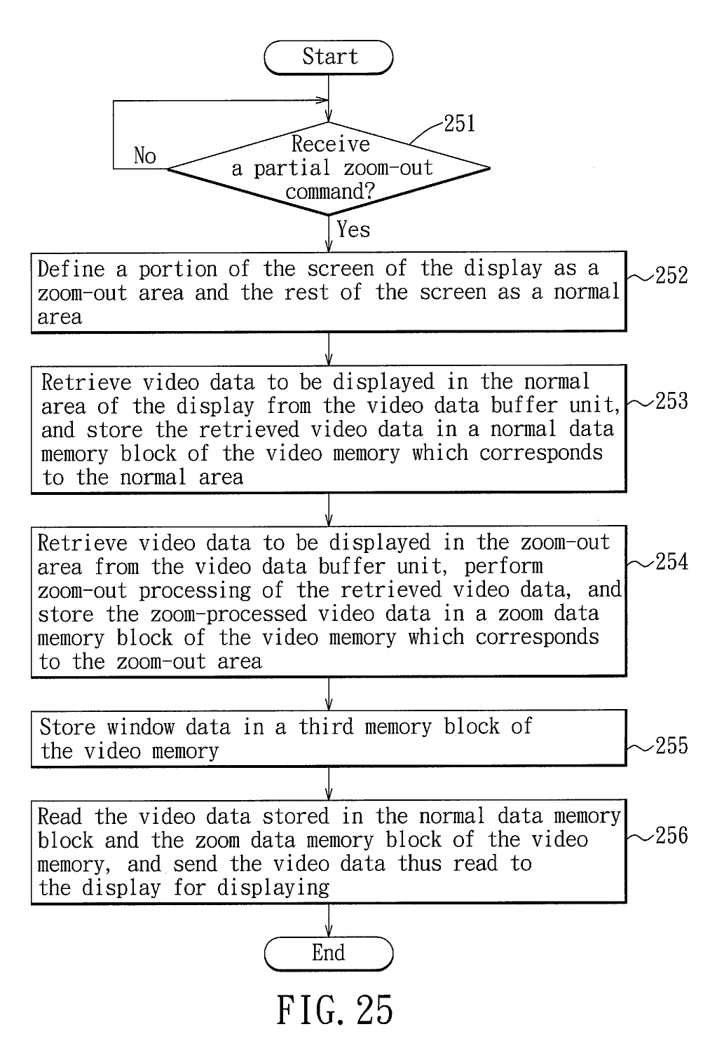

FIG. 25 illustrates another embodiment of an electronic device. The circuit blocks of this embodiment are completely identical to those of the embodiment described in connection with FIG. 14. The only difference is that the central processing unit 12 performs the partial zoom-out function by executing a partial zoom-out application instead of by executing the partial zoom-out driver. The process carried out by the partial zoom-out application to reduce a portion of the content shown on a screen will be described in detail below by way of an example.

Supposing it is also desired to reduce the line of text “CCCCC” on the screen 40 shown in FIG. 15, when the partial zoom-out application receives a “partial zoom-out command” in step 251 of FIG. 25, in step 252, line 3 of the screen 40 is defined as the zoom-out area 191, and the rest of the screen 40 is defined as the normal area (including upper and lower normal areas 192, 193), as shown in FIG. 20.

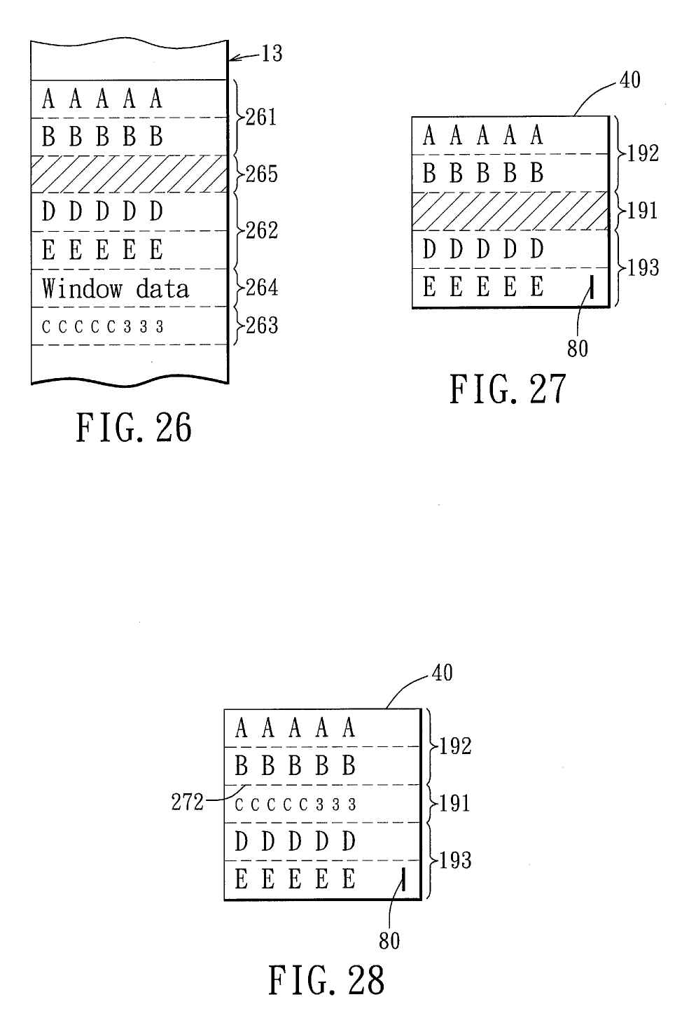

Subsequently, in step 253, the central processing unit 12 reads video data to be displayed in the upper normal area 192 (i.e., lines 1 and 2), i.e., “AAAAA” AND “BBBBB,” from the video data buffer unit 11 of FIG. 17, and stores the video data read thereby in a first memory block 261 of the video memory 13 as shown in FIG. 26, and further reads the video data to be displayed in the lower normal area 193, i.e., “DDDDD” and “EEEEE,” from the video data buffer unit 11, and stores the video data read thereby in a second memory block 262 of the video memory 13. Thereafter, in step 254, the central processing unit 12 reads the video data to be displayed in the zoom-out area 191, i.e., “CCCCC333,” from the video data buffer unit 11, performs zoom-out processing of the video data read thereby, and stores the zoom-processed video data in a zoom data memory block 263 of the video memory 13 as shown in FIG. 26. Moreover, in step 255, window data to be displayed in the zoom-out area 191 is stored in a third memory block 264 of the video memory 13. The first memory block 261 and the second memory block 262 are not arranged contiguously but in sequence in different regions of the video memory 13, with a blank memory space 265 of a size equivalent to that of the zoom data memory block 263 therebetween. The third memory block 264 and the zoom data memory block 263 are arranged in sequence after the second memory block 262.

Accordingly, in step 256, when the video processing unit 14 is controlled by the central processing unit 12 to read the video data in sequence from the first memory block 261, the blank memory space 265, and the second memory block 262 of the video memory 13 and to send the video data read thereby to the display 10, as shown in FIG. 27, the video data “AAAAA,” “BBBBB,” “DDDDD,” and “EEEEE” of normal size will be correspondingly displayed in the upper normal area 191 (i.e., lines 1 and 2) and the lower normal area 193 (i.e., lines 4 and 5), and a blank space is formed at the zoom-out area 191 (i.e., line 3). When the video processing unit 14 subsequently reads the window data in the third memory block 264 of the video memory 13 as shown in FIG. 26 and sends the video data read thereby to the display 10, as shown in FIG. 28, a zoom-out window 272 will be generated and will overlap the blank space in the zoom-out area 191. When the video processing unit 14 continues to read the zoom-processed video data “CCCCC333” from the zoom data memory block 263 of the video memory 13 of FIG. 26 and sends the video data read thereby to the display 10, the zoom-processed video data can be entirely displayed in the zoom-out window 272.

Similarly, as shown in FIGS. 22 and 24, when the cursor 80 is at the last line, i.e., line 5, if the user controls the cursor 80 to move down one line, the central processing unit 12 updates the video data stored in the video memory 13 in real time by retrieving, once again, the corresponding video data from the video data buffer unit 11 shown in FIG. 17, and storing the retrieved video data in the first and second memory blocks 261, 262, and the retrieved and zoom-processed data in the zoom data memory block 263 of the video memory 13 shown in FIG. 26, so that all the video content on the screen 40 moves up one line. As a result, referring to FIG. 23, the first line of text “AAAAA” is pushed out of the screen 40, a new line of text “FFFFF” appears at the last line, and the zoom-processed data “DDDDD444” is displayed in the zoom-out area 191 on the screen 40.

In addition, it is noted that, while the provision of the zoom-out window 272 in this embodiment assists in the sending of the zoom-processed video data by the video processing unit 14 to the correct position of the display 10 for displaying, the zoom-out window 272 is not essential. The zoom-processed video data can still be directly superimposed upon and displayed in the zoom-out area 191 (blank space) without the zoom-out window 272.

Therefore, through the partial zoom-out application of the fourth embodiment, the text content a user is looking at can be timely reduced to enable the user to view entire lines of text on the screen 40 merely by scrolling up and down. There is no need to scroll left and right in order to view entire lines of text on the screen 40.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electronic device capable of controlling partial zooming of a screen of a display, said electronic device comprising:
a video memory;
a video data buffer unit for storing video data to be displayed;
a central processing unit which defines a portion of the screen of the display as a zoom area and the rest of the screen as a normal area, which retrieves video data to be displayed in the normal area from said video data buffer unit and stores the retrieved video data in a normal data memory block of said video memory that corresponds to the normal area, and which further retrieves video data to be displayed in the zoom area from said video data buffer unit, performs zoom processing of the video data to be displayed in the zoom area, and stores the zoom-processed video data in a zoom data memory block of said video memory that corresponds to the zoom area; and
a video processing unit which reads the video data stored in the normal data memory block and the zoom data memory block of said video memory and which sends the video data read thereby to the display for displaying.

2. The electronic device according to claim 1, wherein the zoom area is located near a central position of the screen of the display so that the normal area is divided into an upper normal area and a lower normal area.

3. The electronic device according to claim 2, wherein said video memory includes a first memory block for storing the video data to be displayed in the upper normal area, a second memory block for storing the video data to be displayed in the zoom area, and a third memory block for storing the video data to be displayed in the lower normal area which are arranged sequentially and successively, the normal data memory block including the first and third memory blocks, the zoom data memory block including the second memory block, said video processing unit reading the video data from the first memory block, the second memory block, and the third memory block in sequence and sending the video data read thereby to the display.

4. The electronic device according to claim 2, wherein the zoom data memory block is located after the normal data memory block, the normal data memory block including a first memory block for storing the video data to be displayed in the upper normal area, and a second memory block for storing the video data to be displayed in the lower normal area, the first and second memory blocks being spaced apart by a blank memory space of a size equivalent to that of the zoom data memory block.

5. The electronic device according to claim 4, wherein said central processing unit stores window data in a third memory block located between the second memory block and the zoom data memory block of said video memory, and wherein, when the window data is read by said video processing unit and is sent to the display for displaying on the screen, a zoom window is generated in the zoom area of the screen of the display, said video processing unit reading the video data from the normal data memory block, the third memory block, and the zoom data memory block in sequence and sending the video data read thereby to the display for displaying.

6. The electronic device according to claim 1, wherein said electronic device is a notebook computer, and the display is a display of said notebook computer.

7. A method for partially zooming a screen of a display, said method comprising:
(a) defining a portion of the screen of the display as a zoom area and the rest of the screen as a normal area;
(b) retrieving video data to be displayed in the normal area of the screen, storing the video data in a normal data memory block of a video memory that corresponds to the normal area, further retrieving video data to be displayed in the zoom area of the screen, performing zoom processing of the retrieved video data, and storing the zoom-processed video data in a zoom data memory block of the video memory that corresponds to the zoom area; and
(c) reading the video data stored in the normal data memory block and the zoom data memory block of the video memory, and sending the video data thus read to the display for displaying.

8. The method for partially zooming a screen of a display according to claim 7, wherein the zoom area is located near a central position of the screen of the display so that the normal area is divided into an upper normal area and a lower normal area.

9. The method for partially zooming a screen of a display according to claim 8, wherein, in step (b), the video memory includes a first memory block for storing the video data to be displayed in the upper normal area, a second memory block for storing the video data to be displayed in the zoom area, and a third memory block for storing the video data to be displayed in the lower normal area which are arranged sequentially and successively, the normal data memory block including the first and third memory blocks, the zoom data memory block including the second memory block, the video data in the first memory block, the second memory block, and the third memory block being read in sequence and being sent to the display.

10. The method for partially zooming a screen of a display according to claim 8, wherein, in step (b), the zoom data memory block is located after the normal data memory block, the normal data memory block including a first memory block for storing the video data to be displayed in the upper normal area, and a second memory block for storing the video data to be displayed in the lower normal area, the first and second memory blocks being spaced apart by a blank memory space of a size equivalent to that of the zoom data memory block.

11. The method for partially zooming a screen of a display according to claim 10, wherein, in step (b), window data is further stored in a third memory block located between the second memory block and the zoom data memory block of the video memory, the window data being read and sent to the display for displaying on the screen, so that a zoom window is generated in the zoom area of the screen of the display, the video data in the normal data memory block, the third memory block, and the zoom data memory block being read in sequence and sent to the display for displaying.
